(19) United States
(12) Patent Application Publication
(10) Pub. No.: US 2011/0016064 A1
(43) Pub. Date: Jan. 20, 2011

(54) Patient Management Support System for Patient Testing and Monitoring Devices

(76) Inventor: Kenneth Edward Barton, Beverly Hills, CA (US)

Correspondence Address: Kenneth Barton, 9901 Durant Drive, Unit F, Beverly Hills, CA, 90212, US

(21) Appl. No.: 12/836,015

(22) Filed: Jul. 14, 2010

Related U.S. Application Data
(60) Provisional application No. 61/225,211, filed on Jul. 14, 2009.

(51) Int. Cl. G06F 3/01; G06F 15/16; G06F 17/20; H04L 9/32; G06F 21/00

(52) U.S. Cl. 706/11; 715/734; 726/7

(57) ABSTRACT

An information management, analysis and response generation system is used with monitoring devices for the remote testing and monitoring of system users' physiological information (e.g. diabetes testing, blood pressure testing, anti-coagulation, etc.). The information management, analysis and response generation system allows testing and monitoring devices manufactured by third party companies to communicate with the system through existing communication networks means enabled by proprietary technology. Upon analysis of the collected data, the system is capable of initiating communications with third parties, including interactive clinical alert notifications.

### FIELD OF THE INVENTION

Embodiments of the invention relate to methodologies, systems and associated methodologies for supporting devices (hard-wired devices and wireless devices) used for measuring and/or testing (e.g., by medical personnel) and monitoring including for testing, self-testing and self-monitoring (e.g., medical patients). These methodologies, systems and associated methodologies for supporting these devices include the integration into electronic systems and records (e.g., patient electronic medical records); evaluating pre-set testing parameters that trigger interactive notifications (e.g., clinical and emergency notifications, primary care physician/medical professional notifications, and patient notifications). These methodologies, systems and associated methodologies for supporting these devices also include integration into other systems (e.g., insurance billing systems, communications and network support billing systems, medical billing systems, patient management systems, practice management systems and similar systems used for tracking and maintaining patient and clinical information). The healthcare application of the system supports devices inside and/or outside of a Point of Care or clinical location (“PATIENT TESTING AND MONITORING DEVICE SUPPORT SYSTEM” or “PTMSS”).

### BACKGROUND INFORMATION

Since the inception of modern electronic Patient Testing and Monitoring devices there has been much research into the convergence of medical technology and communications. Some convergence has been accomplished to a point that there are hard-wired and wireless enabled devices that are currently in use in hospital and clinical settings for “in-patient” care. The hard-wired devices are connected via wire line to remote monitoring within the confines of the facility. The wireless devices are mostly limited to cardiac/patient status monitors worn by the patient, wireless to a unit in the hospital room and connected via wire line to remote monitoring within the confines of the facility. On site monitoring is usually accomplished through technical staff in a central location continually monitoring devices on a computer and/or at a “Nurses Station”. Notification of patient test or monitoring problems is done by an alarm on a nurses' station screen, phone call, pager or public address type system to the responding medical personnel within the facility. This requires significant human labor for interaction and coordination by multiple parties to monitor and react to patient condition changes as recorded by current testing and monitoring devices. These Patient Testing and Monitoring devices are for constant patient monitoring, not for periodic testing (i.e., blood glucose levels). Thus, there has long been a need for a system that automates interaction and coordination so as to fully support continuity of care, disease management, and quality of care and economic convergence of services.

One of the difficulties in providing a communication solution (i.e., hard-wired or wireless based service) for PTMSS devices has been that at the same time electronic medical technology has evolved, so has the technology in the communications arena. However, during these evolving processes of technologies, the requirements of the medical business were not fully embraced by the communications business. The communications business has only supported certain limited applications of the healthcare business rather than seeking to understand the overall requirements of health care. Current support systems have been initiated primarily by communications equipment manufacturers in enabling Point of Care devices via wireless or wire line connections (i.e., devices that continually monitor patient functions). These devices are limited in that they are medical testing and monitoring devices, adapted to work on a specific communications network. The devices are designed to work within a clinical environment, by trained clinicians and monitored by personnel on site. Such Systems provide limited functionality and do not provide a fully integrated solution. Currently there is no common data structure protocol or technology that provides the functionality and security that the PTMSS can provide. Current data systems are mostly field fill structures that require manual queries by a trained operator to retrieve information. Furthermore, the information is not regularly integrated by indices, collated or monitored for specific parameters and provide limited functionality in applications such as automatic notification (e.g., clinical alerts). The Systems were designed for specific purposes as stand alone solutions with limited or no designed interoperability. Conversely, the medical business does not fully understand the communications business and has predominantly sought communications support for specific applications and not overall patient care and management solutions.

Current systems in use are either hard-wired or operate on low power unlicensed networks (similar to the range of existing WiFi), not many solutions include long-range wireless communications networks capabilities. Solutions that do include long-range wireless communications provide limited functionality. Additionally, the networks have to be integrated into existing systems and do not work well within the confines of the physical clinical or hospital environment. The very construction of hospitals and clinics with significant piping, electrical and air handling systems tend to interfere with wireless communications, particularly wireless communications systems that operate at very low power. This has been an impediment to developing solutions using mobile/cellular networks in the past (most systems have been developed for Point of Care applications). The US Federal Communications Commission (FCC) in the US, the European Union Communications Ministry (EUC) and the International Telecommunication Union (ITU) has yet to establish finite guidelines and frequencies for use in clinical environments. One accomplishment has been to promote the testing of existing wireless communications for interference with the operation of electronic medical equipment. This has been done so that the health care community as a whole understands what wireless device frequencies and power levels are acceptable for use in clinical/hospital settings to reduce the risk of interfering with electronic medical equipment. The US FCC, EUC and ITU are the leading authorities in establishing communications protocols worldwide.

The structure of the communications business can be complicated for those not directly involved. The basic structure involves Equipment Manufacturers, licensed Common Carriers, Regional Operating Companies, Resellers, Wireless Carriers, Rural Telephone Companies, Cable Companies, Internet Service Providers and Local Exchange Carriers. It is a daunting task for anyone that has little or no knowledge of communications to figure out who to go to and what to ask for when it comes to any type of communications support. Therefore, any system proposed usually fails or has limited effect due to a lack of understanding of the requirements of either party in their respective businesses. Wireless support of medical testing and monitoring devices outside of a clinical setting has yet to be embraced by the Wireless Carrier business. The problem is that Carriers are focused more on providing mobile phone, text messaging, Internet access and content delivery to the consumer market as these are the major profit centers. Furthermore, the very structure of the Wireless Carrier business limits access by virtue of the way the business is organized. In order to sell a Carriers service, one must enter into a “Reseller Agreement” in order to provide “private label” service to customers. Example: say a major electronics retailer wants to sell its own brand of a mobile appliance. It first has to enter into a Reseller Agreement with a Wireless Carrier and register as a Mobile Virtual Network Operator or “MVNO”. This allows the appliances sold by the retailer to be operated on the Wireless Carriers network. Then the retailer would have to pay a significant deposit (sometimes in the millions of dollars) to set up the service and sell mobile appliances. Additionally, the Wireless Carrier will require a significant minimum annual payment to support the private label service regardless of revenues. This structure makes support for devices extremely expensive at the entry level and for the most part, not economically viable.

Current methods in use in patient care are mostly paper based charts and information that have to be entered manually into a patient medical record—then if there is a process in place it might be transcribed into an Electronic Medical Record, therefore introducing the possibility of human error. There is no single standard or protocol for maintaining patient records, test and/or monitoring data records, clinical alert systems, disease management, validation of information, validation of care, continuity of care or patient tracking. Although there are many types of software and technology for patient electronic medical record keeping and practice management, they are mostly proprietary stand alone systems, software or technology that often are difficult to integrate into existing database or clinical management systems, if at all, with limited functionality.

With the advent of the Internet, there has been more interest and research in devices that can be supported by communications outside of a hospital environment or clinical Point of Care facility.

However, these devices and the support mechanisms lack any true bi-directional Clinical Alert System support that can be set with patient testing and monitoring parameters, geographic location parameters and provide multiple paths of notification to/from a Physician, Point of Care Facility, the Patient Emergency Medical Services or other entities that may require such notification or interactive communication. Such systems may have limited or no integration into the various depositories for patient electronic medical records or into associated billing systems.

### DEFINITIONS OF NUMBERED ELEMENTS

(#1) MICRO CONTROLLER UNIT WITH RAM AND PERSISTENT MEMORY (MCU):

A single chip that contains the processor (the CPU), non-volatile memory for the program (ROM or flash), volatile memory for input and output (RAM), a clock and an I/O control unit.

(#2) UART, SERIAL, USB AND IrDA INTERFACE:

Interfaces to facilitate communications to measurement/testing device(s).

(#3) SHORT/MID/LONG Radio Frequency (RF) INTERFACE:

Method or piece of equipment enabling transfer of information over a distance without the use of electrical conductors or “wires”. The distances involved may be short (a few meters as in television remote control) or long (thousands or millions of kilometers for radio communications). When the context is clear, the term is often shortened to “wireless”.

(#4) ALTERNATIVE REMOTE COMMUNICATION INTERFACE:

A method or piece of equipment enabling transfer of information over a distance without the use of electrical conductors or “wires” not using radio frequencies.

(#5) ENCRYPTION/DECRYPTION MODULE:

Module for encrypting and decrypting communications.

(#6) COMMUNICATIONS MODULE:

Module that is capable of sending and receiving communications via wireless means. This module includes Global Positioning System (GPS) capabilities.

(#7) SMART CARD or SUBSCRIBER IDENTITY MODULE (SIM):

Technology used to track and bill subscribers/users on mobile telephony devices.

A subscriber identity module (SIM) on a removable SIM card securely stores the service-subscriber key (IMSI) used to identify a subscriber on mobile telephony devices (such as computers and mobile phones). The SIM card allows users to change phones by simply removing the SIM card from one mobile phone and inserting it into another mobile phone or broadband telephony device.

A SIM card contains its unique serial number, international unique number of the mobile user (IMSI), security authentication and ciphering information, temporary information related to the local network (also temporary local id that has been issued to the user), a list of the services the user has access to and two passwords (PIN for usual use and PUK for unlocking).

(#8) MICROPHONE:

A device for converting sound into electrical energy.

(#9) SPEAKER:

Electro-acoustic transducer that converts electrical signals into sounds loud enough to be heard at a distance.

(#10) BATTERY/POWER SOURCE:

A device containing an electric cell or a series of electric cells storing energy that can be converted into electrical power (usually in the form of direct current).

(#11) DISPLAY INTERFACE:

The Digital Visual Interface (DVI) is a video interface standard designed to provide very high visual quality on digital display devices such as flat panel LCD computer displays.

(#12) TOUCH SCREEN DISPLAY:

A display that can detect the presence and location of a touch within the display area. The term generally refers to touch or contact to the display of the device by a finger or hand. Touch screens can also sense other passive objects. The ability to interact directly with a display typically indicates the presence of a touch screen.

(#13) FINGERPRINT SCANNER:

A device that can scan a fingerprint to be used to compare the digitized image/data with fingerprints in a database of authorized users.

(#14) BIOMETRIC MODULE:

Processes the scanned fingerprint or other biometric reading to be used to compare the digitized image/data with fingerprints in a database of authorized users.

(#15) INPUT INTERFACE:

The graphical, textual and auditory information the program presents to the user, and the control sequences (such as keystrokes with the computer keyboard, movements of the computer mouse, and selections with the touch screen) the user employs to control the program

(#16) WIRELESS ANTENNA:

Component of radio/radar systems that directs incoming and outgoing radio waves.

(#17) GPS ANTENNA:

Antenna that assists the GPS receiver pick up the signals being sent out by the Global Positioning Satellites, giving GPS tracking device in the Communications Module more accurate information to make their position calculation with.

(#18) CAMERA

A piece of equipment used for taking photographs or pictures that encodes an image digitally and store it for later reproduction.

(#19) MEASUREMENT/TESTING DEVICE:

A Device that measures readings to identify characteristics.

(#20) BIOPHYSICAL TESTING MODULE:

A module that measures biophysical parameters.

(#21) HARD WIRED COMMUNICATIONS INTERFACE:

A method or piece of equipment enabling transfer of information over a distance with the use of electrical conductors, fiber optic or wired means.

(#22) REMOTE ACCESS TERMINAL:

A terminal/computer connected to a computer system by a data link.

(#23) ALTERNATIVE BIOMETRIC READER

Biometric readers other then finger print scanners such as a biometric eye-scanner.

(#24) COMMUNICATOR DEVICE:

A M2M universal communication device that is able to communicate with third party medical testing devices and automatically transmit the generated data from these products to the central computer system with minimum to no additional user involvement. The communicator allows for patient interaction to append measurement/testing results taken by third party products. Additional functionality includes GPS capabilities, photographic capabilities, alert functionality, biometric user validation, voice communication capabilities, encryption and decryption capabilities.

(#25) PERSONAL COMMUNICATION DEVICE:

Devise that enables an individual user to communicate with a person or system.

(#26) REMOTE PATIENT MONITORING SYSTEM

A patient testing and monitoring device support system for the remote testing and monitoring of patients' physiological information (e.g. diabetes testing, blood pressure testing, anti-coagulation, etc.). The System allows existing testing and monitoring devices manufactured by third party companies (e.g., Johnson and Johnson, Bayer, Roche, etc.) to communicate with the System through existing landline or wireless means enabled by machine-to-machine technology.

Both clinicians and patients who need to continually test, monitor, record or report patients' results in order to update medical, test and monitoring records benefit from the System. The System will allow results to be sent directly into the patient's Electronic Testing Record and processed according to parameters set into the System by the patient's physician, from which information can be copied to the Patient Electronic Medical Record/Electronic Health Record (PT EMR/EHR).

The System gives general practitioners an additional tool to more effectively diagnose and provide initial treatment for chronic diseases (e.g., diabetes, heart disease, etc.) in early stage care. Having the ability to treat early onset of chronic diseases, such as diabetes, in a timely manner can reduce healthcare costs and the onset of additional, more serious maladies that typically can accompany these diseases.

The System provides: (i) significant reduction of healthcare costs, (ii) true continuity of care; (iii) interactive clinical alert solutions; (iv) support for a interactive disease management system; (v) practice management “best practices”; (vi) patient discharge management; and (vii) full integration into existing systems and; (viii) secure identity management through biometrics.

The System is able to establish communications via cellular networks, wireless terrestrial broadband, landline, satellite based networks, the Internet, and support in-bound and out-bound communications via text, email, conversation, and electronic data exchange, and store the information in proper formats linked to patient profile and data tables in the system.

The system also communicates with other Point-of-Care and external resources, such as patient medical records management entities and/or archives, insurance carrier and medical billing systems, hospitals and doctors. The System also by design manages the proper protocols for exchanging information in support of the patient's file.

(#29) ALTERNATE COMMUNICATION METHOD:

Any communication method not mentioned in this document.

(#30) FAX COMMUNICATION:

A printed page or image transmitted or received by a fax machine.

(#31) E-MAIL COMMUNICATION:

Short for electronic mail, the transmission of messages over communications networks.

(#32) SMS/TEXT MESSAGE COMMUNICATION:

SMS stands for short message service. SMS is also often referred to as texting, sending text messages or text messaging. The service allows for short text messages to be sent from one cell phone or personal communications device to another cell phone or personal communications device or system via the Web or from a system via the Web to cell phone or personal communications device.

(#33) VOICE ENABLED COMMUNICATION DEVICE:

A device capable; given the ability to function in a certain way (e.g. voice-enabled).

(#34) INTELLIGENT DATA ANALYSIS AI/NLP MODULE:

A module that implements the utilization of Intelligent Data Analysis (IDA), Artificial Intelligence (AI) and Natural Language Processing (NLP) technologies.

Intelligent Data Analysis provides a forum for the examination of issues related to the research and applications of Artificial Intelligence techniques in data analysis across a variety of disciplines. These techniques include (but are not limited to): all areas of data visualization, data pre-processing (fusion, editing, transformation, filtering, sampling), data engineering, database mining techniques, tools and applications, use of domain knowledge in data analysis, evolutionary algorithms, machine learning, neural nets, fuzzy logic, statistical pattern recognition, knowledge filtering, and post-processing.

AI is the ability of a computer to continually build a knowledge base of rational components, just as we humans continually learn and evolve in our thought processes. The difference is that the computer learns faster (knowledge base building) and never forgets what it has “learned”. The ability of a computer to continually build its knowledge base and retrieve, use, apply known rationale and logically calculate solutions in real time is AI.

Natural Language Processing is the ability of a computer to recognize human speech and convert it to usable data for processing as text, data, or translating it to another language. This is accomplished in the same fashion as AI in the computer. It has a continually building knowledge base and perpetually refines this knowledge base as it grows. NLP is not simple word recognition. It has evolved into understanding entire bodies of speech and even works of text. Today's advanced NLP technology applies to both speech and text. Additionally, there are image recognition technologies that have been integrated into AI/NLP that now allow computers to essentially “see, hear, speak, translate and write”.

(#35) DATA REPOSITORY:

A database of information that includes author, user, data elements, inputs, processes, outputs and interrelationships. A repository is used in a CASE or application development system in order to identify objects and business rules for reuse. It may also be designed to integrate third-party CASE products.

(#36) PIMS:

The Patient Information Management System (PIMS) is the central repository of all patient testing data, historical data, profiling data, etc. Every patient's measurement is stored here for real-time and post-factum analysis. Health care providers store information regarding individual alerts per patient as well as per class of patients and global alerts here (example: life-threatening values that will trigger alerts). PIMS is also a repository of transcripts of communications between patients and the System, health care provider or emergency response personnel. PIMS will become a repository of structured and unstructured information about patient. It stores patient profiles in addition to meta-knowledge about the patients. All manipulations on the data is audited; data access works according to an Access Control List (ACL); all data is secured to comply with HIPAA and appropriate requirements and standards.

PIMS includes a set of redundant DBs with Web Service Layer APIs. This allows loose coupling of components and ability for 3rd party medical systems (like EHR Electronic Health Record systems) to be seamlessly integrated with the System.

The system is capable of understanding the dialog context of the call and remembering the caller's preferences, knowledge base information from previous calls and other relevant data. In subsequent calls, callers will not have to answer the same questions again, greatly enhancing their experience. If a call is interrupted, the system will call the patient/customer back and pick up the conversation where it left off (where applicable).

This is the repository of the patient's profiles and records. Information and data associated with all communications to and from Remote Monitoring System, POC, and patients are updated in the patient's profile. All trigger events, alarms, thresholds and medical records are maintained and updated in this system.

(#37) COMMUNICATION NETWORK:

Defined by their size and complexity, they come in four main types: (1) small networks, used for the connection of subassemblies and usually A-contained in a single piece of equipment; (2) Local Area Networks, or LAN, cables or fibers used to connect computer equipment and other terminals distributed in a localized area, such as on a college campus; (3) Metropolitan Area Networks, or MAN, a high-speed network used to interconnect LANs spread around a small geographic region such as a city; and (4) Wide Area Networks, or WAN, multiple communication connections, including microwave radio links and satellites, used to connect computers and other terminals over large geographic distances.

(#40) USER:

A user is the person that a software program or hardware device is designed for (e.g., the patient with regards to a remote patient monitoring system).

(#41) AUTOMATIC MEDICATION DISPENSER:

A devise or devises that dispense a patient's medication per instructions from a system that it is connected to through a communication network.

(#42) ADMINISTRATIVE ACCESS TERMINAL:

A terminal or computer remotely or directly connected to a system who's users have security measures in place to only allow authorized persons with predetermined levels of access to access the system.

(#43) ADMINISTRATOR:

An authorized person that has administrative access to view and/or change information in the system. This includes a person employed to maintain and operate a computer system and/or network and/or the person employed who installs, configures, and otherwise maintains the software (and possibly the hardware) associated with a computer system and/or an authorized person that can review and change information, settings and parameters in a users profile on the system.

(#44) WIFI/WIMAX ACCESS/CONNECTION POINT:

A network device that combines a wireless access point (base station), a wired LAN switch and a router with connections to a cable or DSL service. Wireless routers provide a convenient way to connect a small number of wired and any number of wireless computers to the Internet.

(#45) CELLULAR/WIRELESS BROADBAND NETWORK:

Wireless broadband falls into local and wide area categories. Wireless local area networks (WLANs), namely 802.11 Wi-Fi networks, transmit at very high-speed, but Wi-Fi coverage areas (hotspots) are sporadic and span only a couple hundred feet. In contrast, wireless wide area networks (WWANs), provided by the cellular industry's EDGE and 3G (EV-DO and HSPA) technologies, are much slower. However, cell towers span several miles and provide contiguous data service just like they do voice.

(#46) HARDWIRED INTERNET CONNECTOR:

An interface enabling transfer of information over a distance with the use of electrical conductors, fiber optic or wired means.

(#47) COMPUTER WITH INTERNET CONNECTION:

A computer that is connected to other computers (the internet) via modem (examples: telephone, cable, DSL).

(#48) MEASUREMENTS/TESTING RECORD:

A record of a test measuring levels of various substances and detecting various substance types present or absent in the tested matter.

(#49) COMMUNICATION TRANSCRIPTS AND RECORDS:

Software (e.g., AI/NLP and Intelligent speech recognition) turns conversations into formatted documents available for review.

(#50) PHARMACEUTICAL PROVIDER:

A company that sells pharmaceuticals.

(#51) HEALTH CARE MEDICINE PROVIDER:

An individual or a company that buys and/or distributes pharmaceuticals

(#60) WAVEFORM SYNTHESIS:

Waveform synthesis includes the artificial production of human speech. A computer system used for this purpose is called a speech synthesizer, and can be implemented in software or hardware. A text-to-speech (TTS) system converts normal language text into speech; other systems render symbolic linguistic representations like phonetic transcriptions into speech.

Synthesized speech can be created by concatenating pieces of recorded speech that are stored in a database. Systems differ in the size of the stored speech units; a system that stores phones or diphones provides the largest output range, but may lack clarity. For specific usage domains, the storage of entire words or sentences allows for high-quality output. Alternatively, a synthesizer can incorporate a model of the vocal tract and other human voice characteristics to create a completely “synthetic” voice output.

The quality of a speech synthesizer is judged by its similarity to the human voice and by its ability to be understood. An intelligible text-to-speech program allows people with visual impairments or reading disabilities to listen to written works on a home computer.

(#61) WAVE FORM ANALYSIS:

The determination of the amplitude and phase of the components of a complex waveform, either mathematically or by means of electronic instruments.

(#62) HYPOTHESIS GENERATION:

A component that generates a provisionally accepted hypothesis based upon incoming data and analysis utilizing algorithms applicable for process.

(#63) SEMANTIC SYNTACTIC ANALYSIS:

The speech recognizer is able to produce a list of possible words, i.e. a collection of potentially meaningful sentences or sentence fragments, typically represented as a network (a directed acyclic graph). These potential sentences must be converted into logical expressions (propositions), which the dialog system can understand. This “conversion process” can be divided into two autonomous modules: Syntactic parsing and Semantic parsing. This suggests the following general model for the language analysis modules:

The syntactic analyzer performs dictionary lookup from the system's lexical database and applies syntactic rules to these word descriptions. The result of this process, which is called syntactic parsing, is declarative descriptions of the syntactic content (subject, object, adverbials, etc.) of each proposed sentence or sentence fragment, as suggested by the speech/word recognizer. The semantic module will continue the analysis, and it must, among other things, pick out the most suitable interpretation from the input network provided by the speech recognizer.

(#64) RESOURCE MANAGEMENT:

A performance monitoring module that sense current system processes' states and manages system resource allocation to ensure optimal use.

(#65) VOICE STRESS/EMOTION ANALYSIS:

Voice Stress Analysis (VSA) is based on hypothesis that there are infrasonic components of human voice not audible to observers caused by a physiological phenomenon present in muscles called “microtremor”. It was discovered in 1957 by British physiologist Olaf Lippold. Further by other researchers explored the possibility of the presence of microtremor in the muscles controlling the voicebox. The experiment was made by attaching electrodes to the cricothyroid muscle and the posterior cricoarytenoid muscle and measuring EMG signals. Detecting microtremor during sustained speech was not deemed possible because the EMG activity changed too rapidly. The experiment was therefore limited to measuring the presence of microtremor in the frequency range of 1 through 20 Hz in sustained vowel phonation, but yielded no positive results. It was concluded that “the electrical energy was randomly distributed throughout the spectrum.” The inconclsuive research on microtremor in voice production has consequently been used to claim that the phenomenon can be used for creating technology capable of lie detection by detecting microtremor in recorded speech.

(#66) LANGUAGE METADATA KNOWLEDGE BASE:

Component contains data on a phonetic, syntactical and semantic structure of human languages.

(#67) SPEAKER PROFILING KNOWLEDGE BASE:

The process of analyzing and identifying the auditory-perceptual and acoustic characteristics of a given voice sample

(#68) SYSTEM SELF TESTING AND DIAGNOSTICS:

Self-diagnostic/self-testing system controls test parameters within the system to verify that all system components are functioning properly.

(#69) EXECUTOR:

The Executor arranges collaboration and divides up the responsibilities for the components to operate.

(#70) REFLECTION ANALYSIS:

A reflection analysis methodology based upon an interactive, dynamic questioning procedure that implements reflective practices of individual learners. Comprehensive educational activities are designed to model cognitive behaviors of successful students. During interactive diagnostic testing, the learner is asked to reflect on the degree of certainty for each of his answers. After completing the diagnostic test, reflective questions are posed specifically responsive to the learner's answers to selected items. This series of reflective questions is designed to cause the student to search for patterns, clues, and problem-solving strategies related to the specific content being studied. In so doing, thinking behaviors that the student has used or should have used are analyzed, and concomitantly constructs strategic modeling from a database of comprehensive instructional activities for addressing a given concept or skill in the future. System diagnosis provides the teacher with instant feedback on the learner's performance. Thus, the scaffolding of new leaning and follow-up tutorials may be totally customized on a learner-by-learner basis. This customization and individualization is enabled by the branching logic underlying the reflective analysis methodology.

(#71) PREDICTOR CORRECTOR:

Predictor/Corrector is module that implements formal and fuzzy logic functionality as well as algorithms of predictability of close and open systems to generate process-controlling steps.

(#72) ALGORITHMIC KNOWLEDGE BASE:

Set of algorithms, which may be appended and revised that are available to support automated decision-making.

(#73) FACTS KNOWLEDGEBASE:

A collection of knowledge, including facts and information that an ordinary person is expected to know.

(#74) META KNOWLEDGE BASE:

The sum or range of knowledge that has been perceived, discovered, or learned based upon facts and rules of logic.

(#75) ARTIFICIAL INTELLIGENCE MATRIX:

Combination and interaction of elements including 60-74 and 81 creating AI NLP engine and automated decision support system.

(#76) NETWORK INTERFACE:

The network interface is the point of interconnection between a user terminal and a private or public network.

(#77) SUBJECT TESTING/LCM SUPPORT SYSTEM:

System of User Life Cycle Management and testing/measurement support. This system includes administrative access to establish, review, edit, user accounts/user customer service and billing information.

(#78) VOICE GATEWAY:

A network device that converts voice and fax calls, in real time, between the public switched telephone network (PSTN) and an IP network. The primary functions of a VoIP gateway include voice and fax compression/decompression, packetization, call routing, and control signaling. Additional features may include interfaces to external controllers, such as Gatekeepers or Soft switches, billing systems, and network management systems.

(#79) COMMUNICATOR GATEWAYS:

Hardware and/or software that converts one messaging protocol to another that the support system can understand.

(#80) EMAIL/TEXT/FAX/SMS GATEWAY:

Hardware and/or software that converts one messaging protocol to another that the support system can understand.

(#81) DIGITAL SIGNAL PROCESSOR (DSP):

A digital signal processor (DSP) is a specialized microprocessor designed specifically for digital signal processing, generally in real-time computing

Digital signal processing algorithms typically require a large number of mathematical operations to be performed quickly on a set of data. Signals are converted from analog to digital, manipulated digitally, and then converted again to analog form, as diagrammed below. Many DSP applications have constraints on latency; that is, for the system to work, the DSP operation must be completed within some time constraint.

Most general-purpose microprocessors and operating systems can execute DSP algorithms successfully. But these microprocessors are not suitable for application of mobile telephone and pocket PDA systems etc. because of power supply and space limit. A specialized digital signal processor, however, will tend to provide a lower-cost solution, with better performance and lower latency.

The architecture of a digital signal processor is optimized specifically for digital signal processing work.

### DEFINITIONS OF NUMBERED PROCESSES

(#90) Biometric Identification Module

Scanned biometric (Ex. fingertip, iris) data:

(#91) Previously Stored User ID

Internal communicator persistent storage (memory) where biometric authentication of known users is stored.

(#92) Synchronize Communicator User Data with Support System

Process to persist authentication data received from Support System (36) to communicator memory.

(#93) Data Processing Layer

Process of functions, combining Artificial Intelligence and Life Cycle Management components for data processing and classification, including unstructured data.

(#94) Lookup User Information in the Database

Process to search for user biometric data (90) in Data Repository(35) to identify whether user is already registered in Support System (36).

(#95) Generate Unique New User ID

Process of generating global unique user id, that will be used for identification and personalization of measurement data across the whole system.

(#96) Establish Secured Communication Channel With Communicator

Process of establishing secure bi-directional communication for data transfer and synchronization between Support System (36) and Communicator (24).

(#97) Persist Data to the Database

Process of persisting user biometric data(90) to Data Repository (35) for future authentication purposes.

(#98) Administrator Enters New User Account

Administrator (43) enters new user information and establishes new account in Support System (36).

(#100) Measurement/Testing Data

Measurement/testing data—characteristics, identified by measuring of user's biophysical or physical parameters.

(#101) User Response to Queries

User's response to queries (102).

(#102) Communicate Query Questions, Request Retest—Questions for Enhanced Analysis

Queries—set of inquires that user responds to via communicator (24) to provide information, that cannot be automatically measured or entered into the system due to practical reasons.

(#103) Receive Information

Process of receiving data (90, 100, 101) via communications network (37) by Support System (36) for further decryption and processing.

(#104) Measurement Testing Records Storage

Measurement/testing records storage is a part of Data Repository (35) that persist personalized measurement/testing data for processing, analysis and reporting purposes.

(#105) Predefined Questions by Healthcare Provider

Predefined questions by Healthcare Provider—subset of queries (102), default set of questions that is identified by algorithms in Expert System (106) to treat current user medical condition.

(#106) Expert System

Expert System, part of Support System (36) based on Artificial Intelligence (AI) technology capable of analysis and diagnostic of measurement data (100) for the purpose of developing best possible strategy of altering user's conditions according to vector of goals, set by administrator (43).

(#107) Process Collected Information and Historical Records

Processing of collected information and historical records for use by expert system (106) in order to develop best strategy of altering user's conditions according to vector of goals set by administrator (43).

(#108) Combine

Process of combining biometric data (90), Measurement/testing data (100) and User's response to queries data (101) for sending via communications network (37) to remote Support System (36) to ensure that authenticated data can be trusted by (36).

(#109) Internal Processing and Data Relay

All necessary actions happening in Communicator (24) with the data (90, 100, 101) to facilitate secure bi-directional communication with Support System (36) via communications network (37).

(#110) Emergency Notification Workflow

Emergency Notification Workflow—set of actions that communicator (24) is programmed to do when user hits emergency button (111).

(#111) Emergency Button Pressed

Emergency Button—special input device on communicator (24), which upon activating will trigger emergency notification Workflow (110).

(#112) Get Current GPS Location

Process of determining geographic coordinates of communicator(24) by acquiring and processing signals from GPS satellites.

(#113) Voice/Text Communication With User

Voice/Text communication with user—communication between user and/or Administrator (43) and/or Support System (36).

(#114) Notify Emergency Services

Process of notification of 3rd party service (ex. 911 service) in order to escalate user's emergency.

(#115) Voice/Text Input by Patient

User's voice/text input in response to Voice/Text communication with user (113).

(#116) Data Collected from Users

All data including testing/measurements, communications transcripts, etc. collected from users by support system (36).

(#117) Data Collected From Administrators/Healthcare Practitioners

All data, supplied by administrators (43), collected by support system (36).

(#118) Data Collection Service

Module for translating and normalizing incoming data into internally acceptable format.

(#119) Data Classification

Process of data classification to facilitate further business intelligence analysis.

(#120) Reports

Set of data reports used for manual data analysis, identifying trends, etc.

(#121) Notification Interface

Interface for communicating analytical data to 3rd parties, like government or commercial healthcare services.

(#122) 3^{rd} Party Government Services

Any 3rd party organizations or people, granted access to analytical information, generated by Support System (36).

### BRIEF DESCRIPTION OF THE DRAWINGS

FIG. 1 is a block diagram of the communicator schema, according to the invention.

FIG. 2 is a block diagram of the data flow from communication devices to the patient information management system.

FIG. 3 is a block diagram of the practice of the invention using a smartphone communication device.

FIG. 4 is a block diagram of the embedded version of the invention

FIG. 5 is a block diagram of the patient diagnostic information flow.

FIG. 6 is a block diagram of the artificial intelligence matrix.

FIG. 7 is a block diagram of the patient information management system.

FIG. 8 is a block diagram of outbound information exchanges with the patient information management system.

FIG. 9 is a block diagram of the overall flow of information, according to the invention.

FIG. 10 depicts the user authentication workflow between the various components of the invention.

FIG. 11 is a depiction of the user diagnostics workflow of information collected from the user to an external support system.

FIG. 12 is a depiction of the system user query interface.

FIG. 13 is a depiction of the emergency alert trigger workflow.

### DESCRIPTION OF THE ILLUSTRATIVE EMBODIMENT

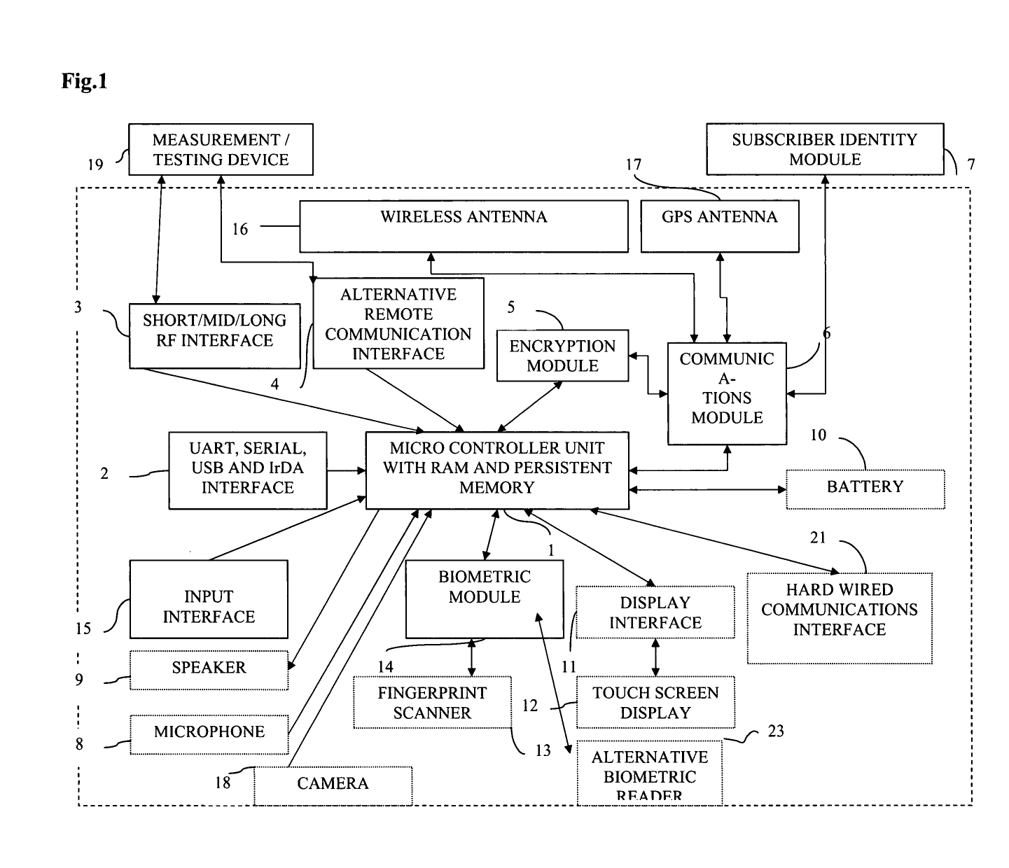

Referring to FIG. 1, MCU(1) is a heart of Communicator device(24) as it provides controlling function for all modules, listed above. MCU(1) establishes communication channel with (19) by wired means (2) or wireless means (3) or (4). Encryption module (5) may or may not be used in data transmission between (24) and (19) depending on capabilities of (19). Communicator device (24) requests measurement data (100) from (19) via created communication channel and (19) transmits data to (24). Then MCU (1) optionally displays request for biometrical data identification of the user (40) via (11) and (12) or (9). User provides biometric input for analysis via fingertip scanner (13) or alternative biometric reader(23) (Ex. iris scanner) for further processing by (14). Biometric data (90) is processed by (14) and MCU (1) verifies it against stored user biometric data in MCU internal memory (91). If verification is successful, 100 and 101 will be personalized by global unique user id that Support System (36) recognizes. Depending on user profile, stored in (91) or by request initiated by (36) MCU (1) may request additional information-queries(102), which can be requested by visual means (11) and (12) or audio means-(9). User responds to Queries (102) with responses(101) by entering information via (12), (8) or (15). Also additional query response information may be entered via camera (18). At the same time MCU(1) collects geographical position coordinates of (24) via communications module (6) and (17). MCU(1) then process all collected information: GPS coordinates, measurement data(100), global unique user id, query responses (101) and packs, encrypts via (5) and transmits data to (36) via (6)+(16) or (21). (6) uses (7) for subscriber identification purposes to register on wireless networks. (24) can not only initiate bi-directional communication with (36) but also accept incoming communication requests from (36). (6) and (21) can also facilitate voice communication with (36) or and (43) via cellular networks or wired networks. Mobile or stationary power source (10) provides power for the entire Communicator Device (24).

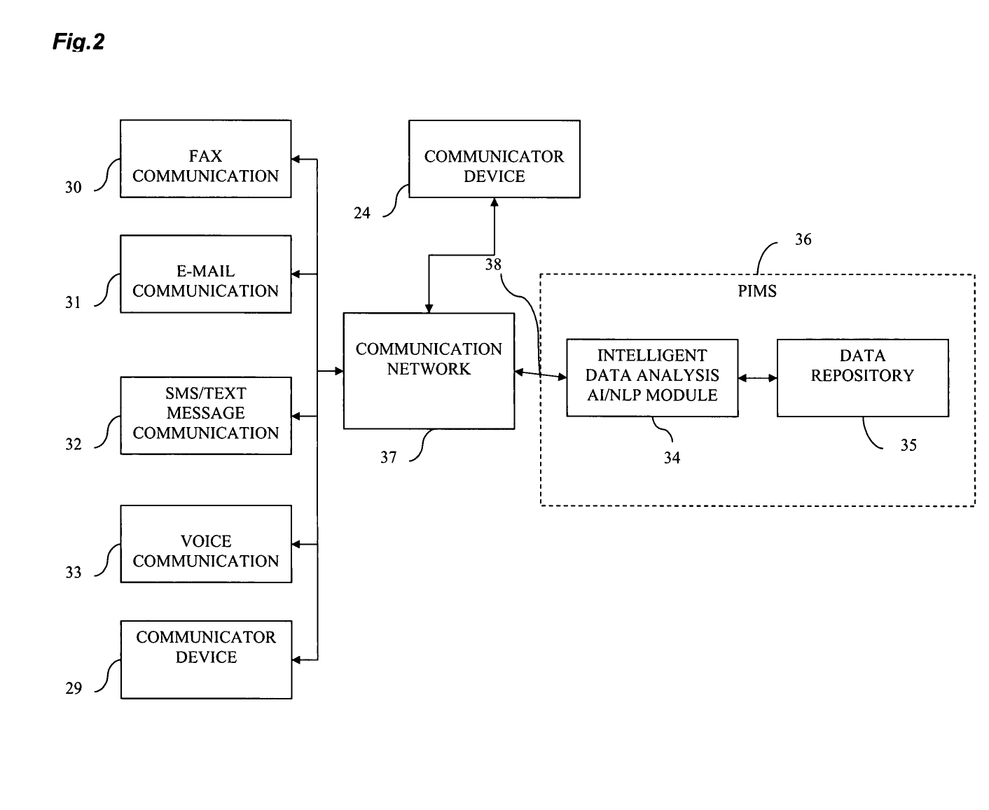

FIG. 2 depicts the various communications modes and devices (24), (29), (30), (31), (32), (33) capable or enabled to interact with PIMS (36). All communications and information flow are bidirectional between the external devices and the system and are accomplished through a communications network (37). For example, an inbound fax communication is transmitted to the system and read by system via optical character recognition and converted to text (34) as may be required by the system and it's users. Outbound fax communications from system are transmitted in facsimile format to receiving fax machine. Short Message System (SMS) or commonly called Text Messages are both received and transmitted by the system dependent upon parameters defined in the system for a particular user. Voice communications are enabled between a voice device and the system dependent upon parameters and instructions for a particular user. The Communicator device is enabled to communicate with the system via various means, including but not limited to data and voice dependent on the device configuration for a given user. PIMS performs information analysis (34), data storage (35), supports user interface, interacts with external devices enabled to communicate with the system and responds to information received by the system (34), (35), (36).

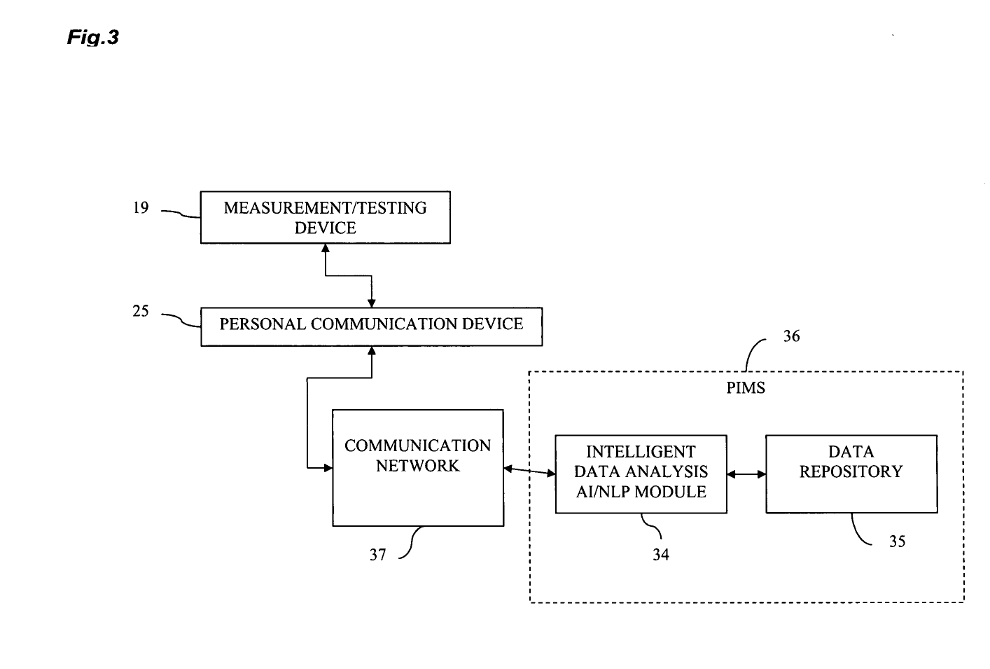

FIG. 3 depicts the basic design and architecture of the overall system and the path of information flow and communications between and end user measurement/test device(s) and the system. All information flow is bidirectional through and with all devices and the system. Wherein (19) transmits and receives information through (25) and (37) to (36). The information received by (37) is then processed by (34) and/or stored by (35) within (36). Information processed by (36) is then transmitted to (19) via (37) and (25) as may be required.

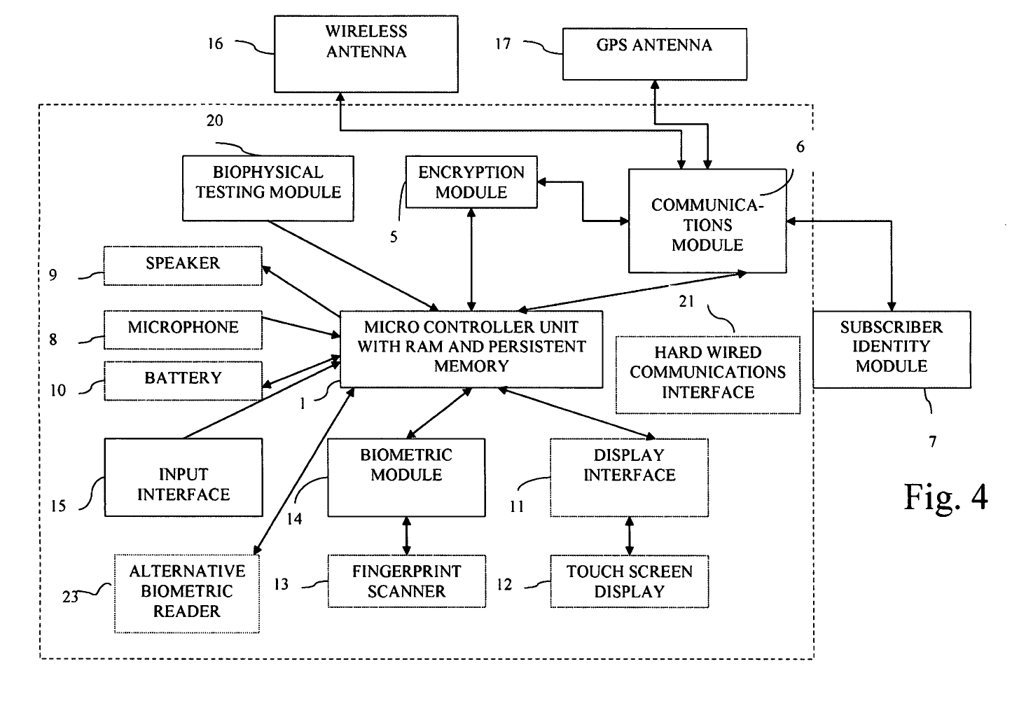

Referring to FIG. 4, MCU (1) is a heart of Communicator device (24) as it provides controlling function for all modules, listed above. MCU (1) requests measurement data (100) from biophysical/physical measurement module (20) and receives it for further processing. Then MCU (1) optionally displays request for biometrical data identification of the user (40) via (11) and (12) or (9). User provides biometric input for analysis via fingertip scanner (13) or alternative biometric reader (23) (Ex. iris scanner) for further processing by (14). Biometric data (90) is processed by (14) and MCU (1) verifies it against stored user biometric data in MCU internal memory (91). If verification is successful, 100 and 101 will be personalized by global unique user id that Support System (36) recognizes. Depending on user profile, stored in (91) or by request initiated by (36) MCU (1) may request additional information-queries (102), which can be requested by visual means (11) and (12) or audio means-(9). User responds to Queries (102) with responses (101) by entering information via (12), (8) or (15). Also additional query response information may be entered via camera (18). At the same time MCU (1) collects geographical position coordinates of (24) via communications module (6) and (17). MCU (1) then process all collected information: GPS coordinates, measurement data (100), global unique user id, query responses (101) and packs, encrypts via (5) and transmits data to (36) via (6)+(16) or (21). (6) uses (7) for subscriber identification purposes to register on wireless networks. (24) can not only initiate bi-directional communication with (36) but also accept incoming communication requests from (36). (6) and (21) can also facilitate voice communication with (36) or and (43) via cellular networks or wired networks. Mobile or stationary power source (10) provides power for the entire Communicator Device (24).

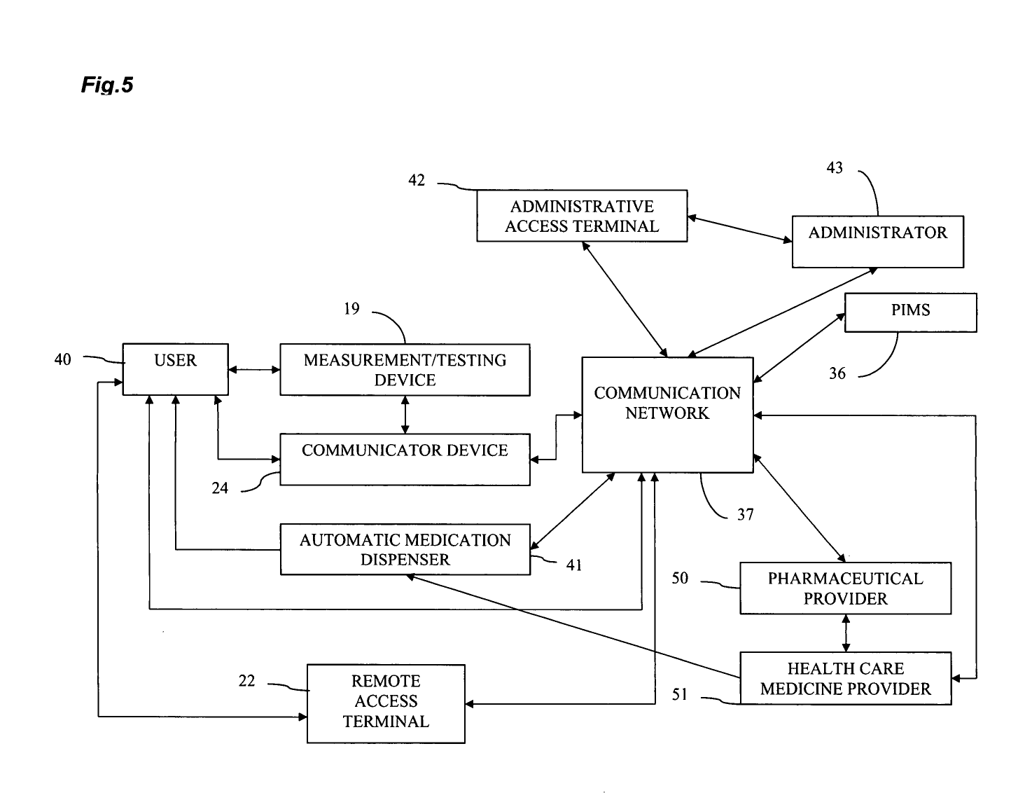

FIG. 5 depicts the overall component structure and the interaction between components of PIMS including external devices, ancillary users and communications networks. Wherein (40) interacts with (19). (40) may communicate to through (37) to (36) via several means including (24) and (22). (19) communicates to (36) via (24) and (37). (036) communicates to (24), (41), (50) and (51) to initiate and/or confirm processes and actions to be completed. Wherein (42) and (43) communicate to (36) via (37) to establish parameters and determine functions to be performed and process information as required by the system users. Wherein a system user may utilize (42) and/or (43) to communicate with (50) and/or (51) to via (37) to transfer data or information, establish processes or determine and confirm actions as may be required by system users.

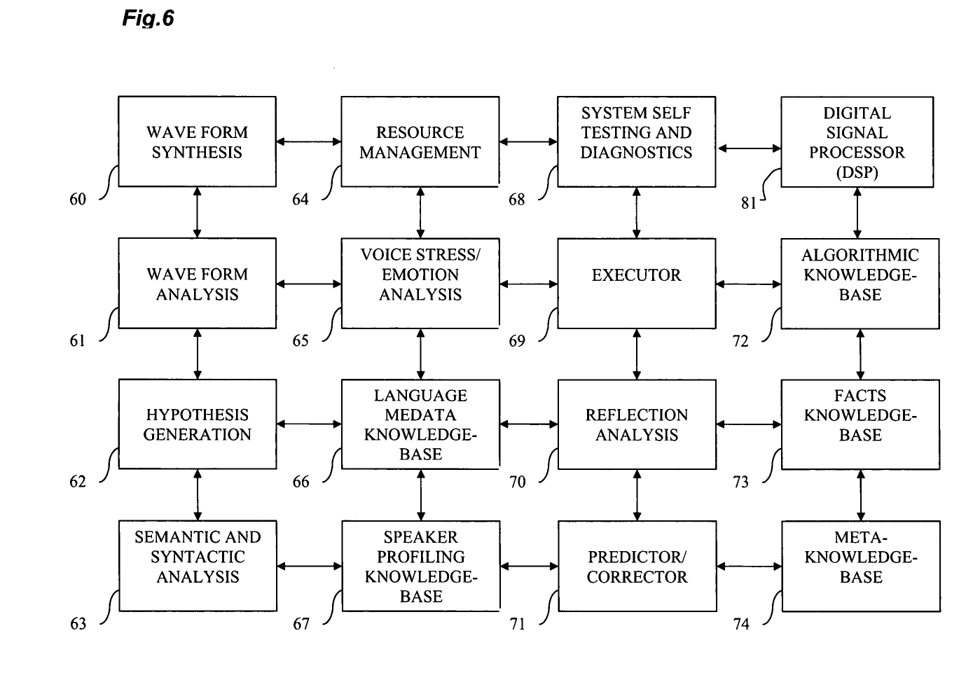

Referring to FIG. 6, all components in the AI Matrix (75) are mutually connected to each other. Natural Language Processing functionality starts from (61) which is capable of frequency/phase audio signal analysis to determine phonemes. Then (62) generates hypotheses of words and phrases based on phonemes from (61), data from (66) and (67). Further refinement of hypotheses happens when semantic and syntactic analyzer (63) along with (70) based on data from (73) and (74) filters out false hypothesis vs. positive hypothesis. Process of refinement of hypothesis set happens several times until (63) ends up with a single hypothesis with the highest probability to be true. Mistakes in hypotheses can be fixed on further steps of natural language dialog when (71) detects false logic conditions. In this case (71) signals (63) about mistake in the chain of decisions, suggests to lower probability of a certain hypothesis and redo refinement of hypothesis list. (67) can be updated with speaker profile to assist further processing of speaker's voice thus system adjusts to voice patterns of an individual speaker and next time process of learning pattern may take less time. (60) can be used in text to voice generation for system to user communication. (65) can be used for emotional/stress analysis of the speaker to generate special events that can be processed by other parts of the system.

Automated Decision Support functionality of the system is comprised of the key components: (70), (71), (72), (73) and (74). Predictor/Corrector (71) is module that implements formal and fuzzy logic functionality as well as algorithms of predictability of close and open systems to generate process-controlling steps. (71) generates process controlling steps according to process algorithms from (72) and data from (73) and (74). (70) is module that generates feedback to (71) with analysis what is the result of process controlling steps, generated by (71). DSP (81) can be used to preprocess incoming information in form of any digital signals (Ex. video) into the form, understandable by (75). Executor (69) is a component of (75) responsible for assigning jobs and facilitating coherent collaboration between components of (75). Resource management (64) is component that manages system computational and memory resources in (75) to achieve optimal use of them. As long as (75) can be used in mission-critical processes, (68) can be engaged in constant self-monitoring and diagnostics to reduce risks, related to possible malfunctioning of (75) itself, communication infrastructure or other components of the system.

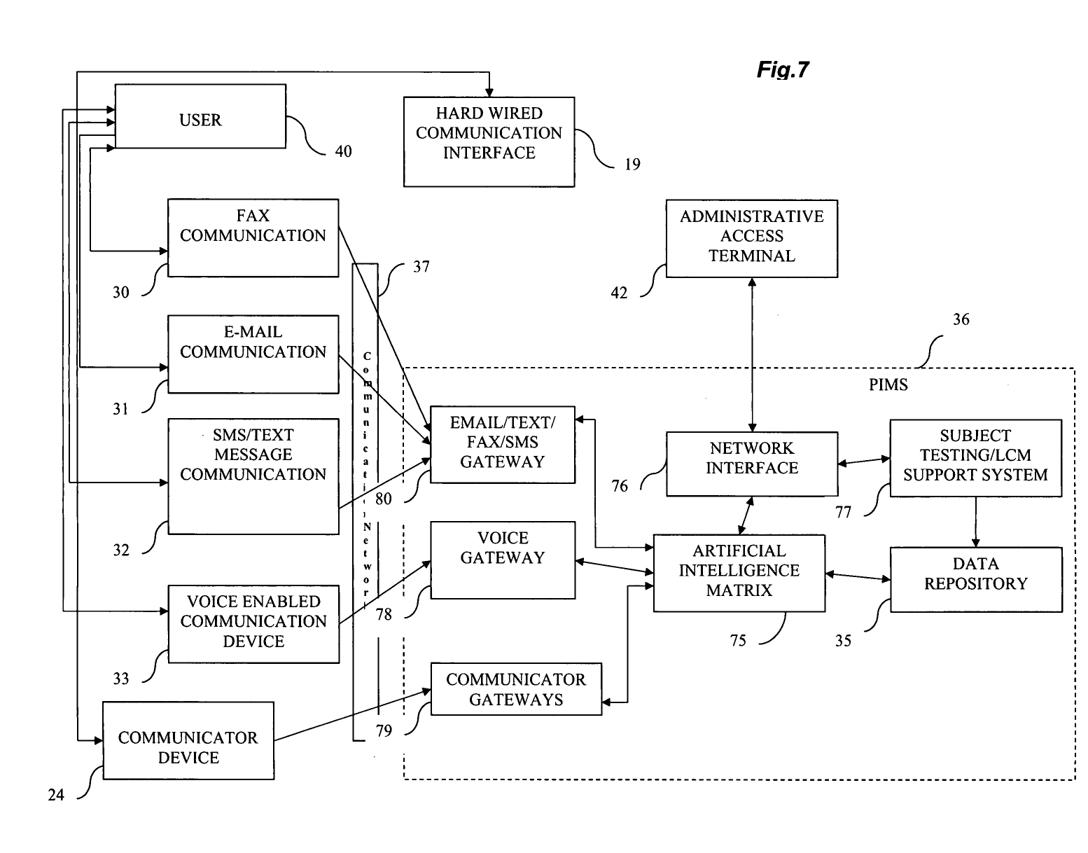

FIG. 7 depicts the various communications modes and devices capable or enabled to interact with PIMS in a detailed block diagram including the internal structure of PIMS modules to interface and interact with other systems, components and networks. All communications and information flow are bidirectional between the external devices and the system and are accomplished through a communications network (37). Wherein (40) may communicate with (36) via any or all of several means including (19), (24), (30), (31), (32), and (33) to (36) via (37). For example, an inbound fax communication is transmitted to the system via (30) and read by system via optical character recognition and converted to text as may be required by the system and its users. Outbound fax communications from system are transmitted in facsimile format to receiving fax machine. Wherein (40) may utilize (31) to communicate via Short Message System (SMS) or commonly called Text Messages are both received and transmitted by the system dependent upon parameters defined in the system for a particular user. Voice communications (33) are enabled between a voice device and the system (36) dependent upon parameters and instructions for a particular user. The Communicator device (24) is enabled to communicate with the system (36) via various means, including but not limited to data and voice dependent on the device configuration for a given user. PIMS performs information analysis, data storage, supports user interface, interacts with external devices enabled to communicate with the system and responds to information received by the system. The internal structures of (36) control interface with (40) via (78), (79) and (80) and (42) via (76). Elements (35), (75) and (77) control processes within (36).

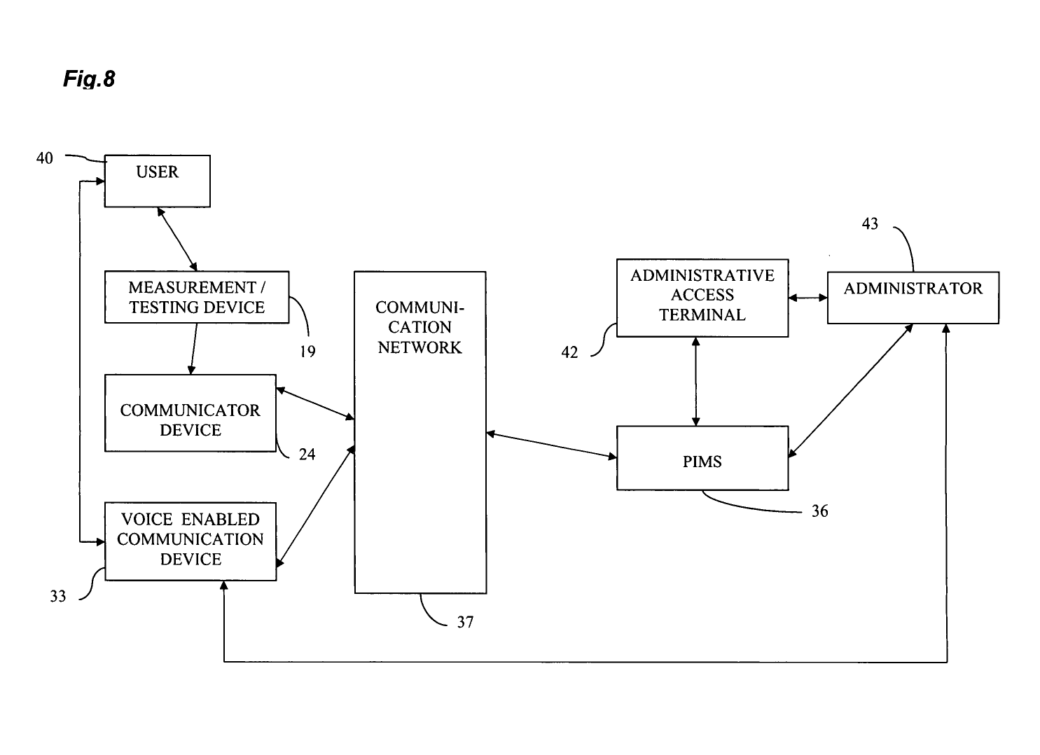

FIG. 8 depicts and overall view of basic interaction operations and capabilities between (40) and (19) and (36) and (43) depending on the system configuration and user requirements. Wherein (40) may establish bidirectional communications with (43) via (37). (43) has access to (36) via (42) to establish parameters, determine functions and control information flow. Depiction of information and data flow path between (40) via (19) and (24) through (37) to (36).

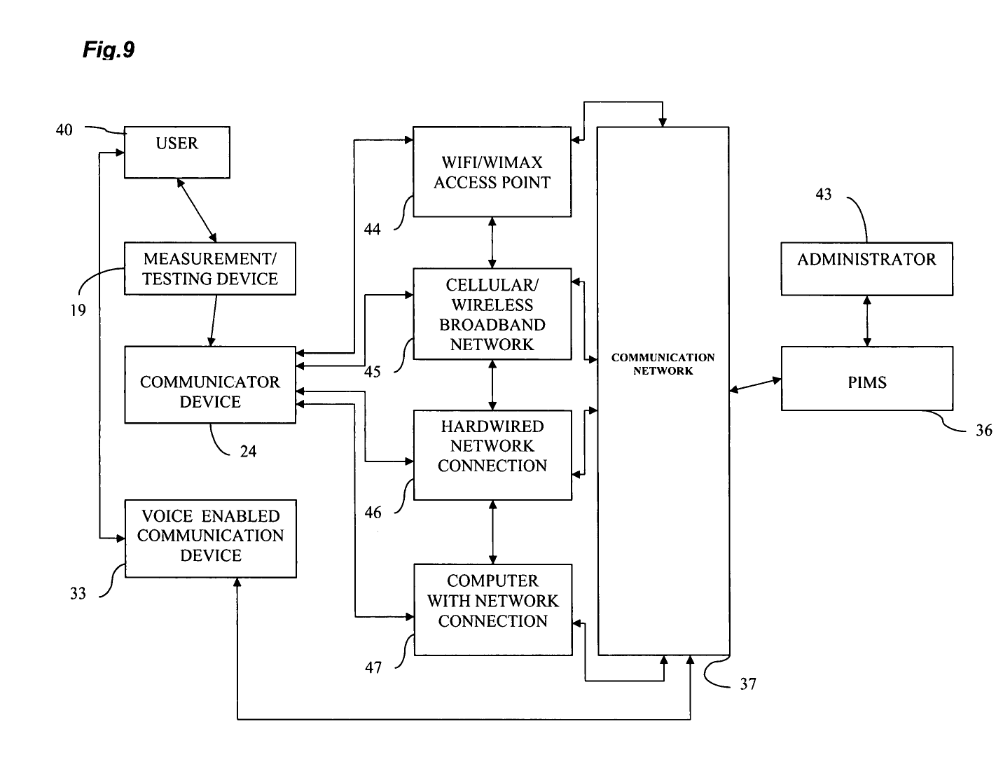

FIG. 9 depicts the various configurations and communications modalities that may be utilized by (40) to transmit and receive data and information to and from (36) and (43) via (19), (24), (33), (44), (45), (46), (47) and (37). Wherein upon interaction between (40) and (19), data is transmitted to (24) and depending on requirements and configurations determined by the users of the system, may further transmit data and information to (36) via any one, all, or a combination of the available communications modes depicted by (44), (45), (46), (47), or (33). For example: (40) utilizes (19) to test for specific biophysical information. The information collect by (19) is then transmitted to (24) where upon (24) transmits the data or information to (36) via (37) utilizing the functions of (44). Element (43) is utilized by system authorized users to accesses (36) to view, establish and retrieve information as well as establish parameters, determine threshold events, configure control functions and verify data and information contained within (36) and determine actions to be taken by (36) upon receipt of information and data from (40).

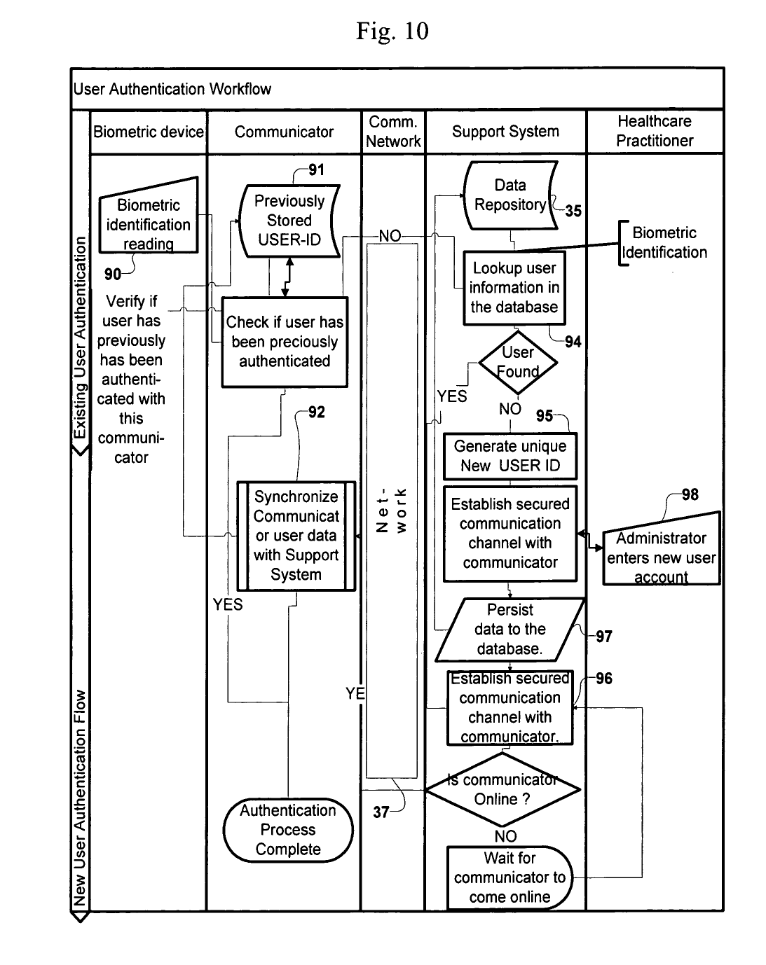

Referring to FIG. 10, user authentication workflow starts from user (40) providing biometric identification reading (90). Communicator compares (90) with all user data profiles, stored in (91). If user profile matched, authentication process completes at this step. If user profile did not match, communicator (24) establishes secure communication with support system (36) via (37). (24) then transmits (90) to support system (36) in order to lookup whether user profile already exists in (35). If user profile is found, then (36) either reuses existing communication channel or establishes new secure communication channel (96) via (37) and transmits global unique user id along with cryptographic hash of (90) to communicator. Communicator then launches synchronization process (92) that associates biometric reading (90) with global user id with the help of hash and authentication process completes at this step. If user profile was not found in (35) then new user registration workflow starts. (36) generates new global unique user id (95), notifies administrator (43) which establishes new user account (98). After account was established, system persists data (97) to (35), establishes new secure communication channel (96) via (37) with (24) or reuses existing channel. Communicator then launches synchronization process (92) that associates biometric reading (90) with global user id with the help of hash and authentication process completes at this step. If connection to communicator cannot be established immediately system waits and retries.

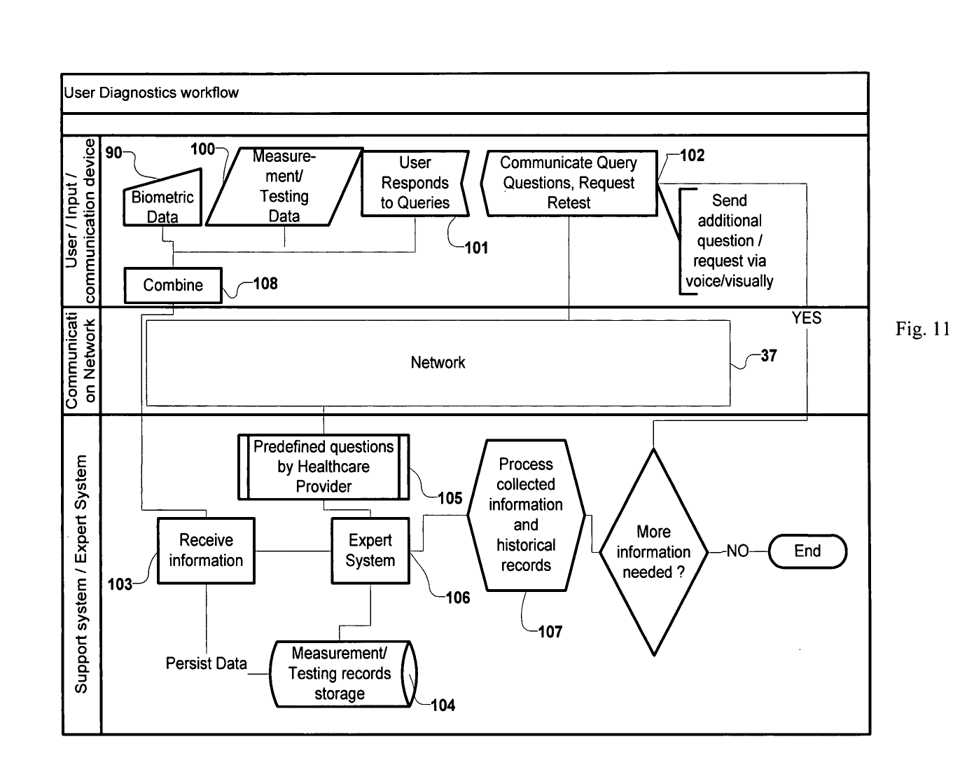

Referring to FIG. 11, user diagnostic workflow starts from communicator (24) collecting biometric data (90), Measurement/testing data(100) and user queries answers (101). (100) and (101) can be personalized with global unique user id by means of (90) and sent via communications network (37) to support system (36). (36) can receive information (103), decrypt, preprocess it and store in (104). (103) also can send data to expert system (106) that in conjunction with (107) can process and analyze current, historical data according to algorithms identified by administrator (43). If (106) and (107) determine, that predefined queries(105) are not adequate for the user or system doesn't have enough information about user, system can trigger addition queries(102) to communicator device to inquiry more information from the user that will be delivered back to the system from communicator(24) via (37).

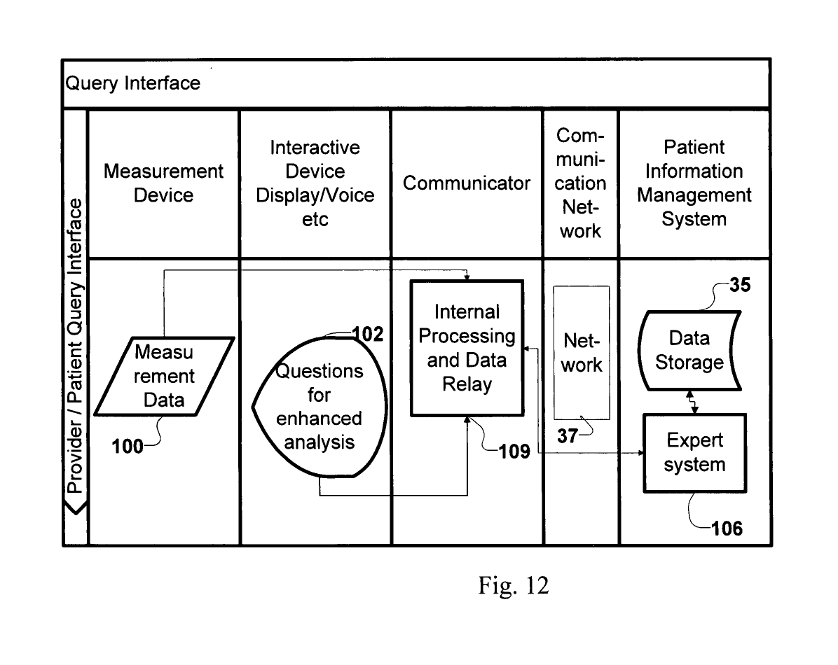

FIG. 12 depicts the overall query interface and function of the PIMS as combined with the embedded technology of the Communicator. The query function is designed to act upon information received from (100) via (109) and (37) in to (106). Wherein (106) conducts analysis on the information combined with information from (35) to determine query requirements, if any. If there is further action required, as determined by the users of the system and parameters set forth therein, (106) will then transmit a request to (109) via (37) for (102) to generate the appropriate query and display same on the Communicator display for response by the Communicator user. Wherein element (102) may have predetermined queries to be displayed on the Communicator for the user as determined by the authorized system users. Additionally, (106) may generate custom queries not previously programmed or loaded into (102) as further analysis of information received is completed requiring more information from the user via (100) such as retesting and re-transmitting test data to confirm previous information received or generate new information in the event of an initial errant data or information transmission. For example: An initial test from (100) transmits data to (106) that is not within established parameters for the user, the system then generates a query transmitted back to the user to re-test to confirm initial data or to transmit correct data due to a failed initial data transmission. In the event the initial data is confirmed. The system will then proceed with actions as determined by authorized system users and actions to be taken such a generating an alert or contacting third party personnel or entities as may be the case.

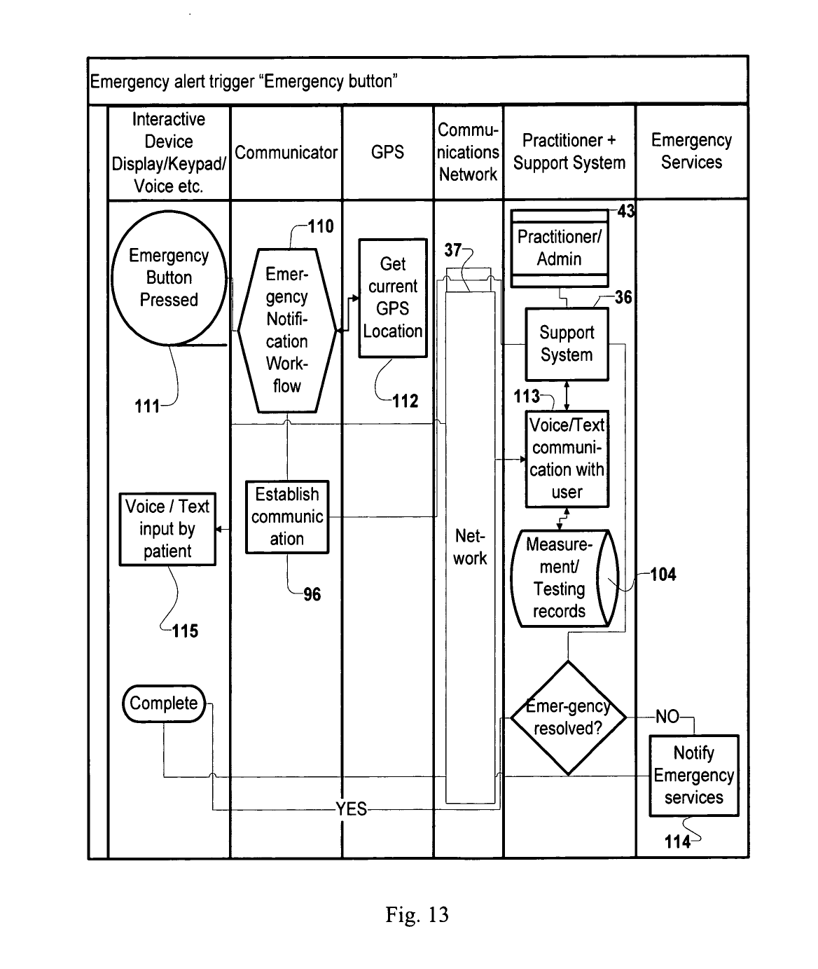

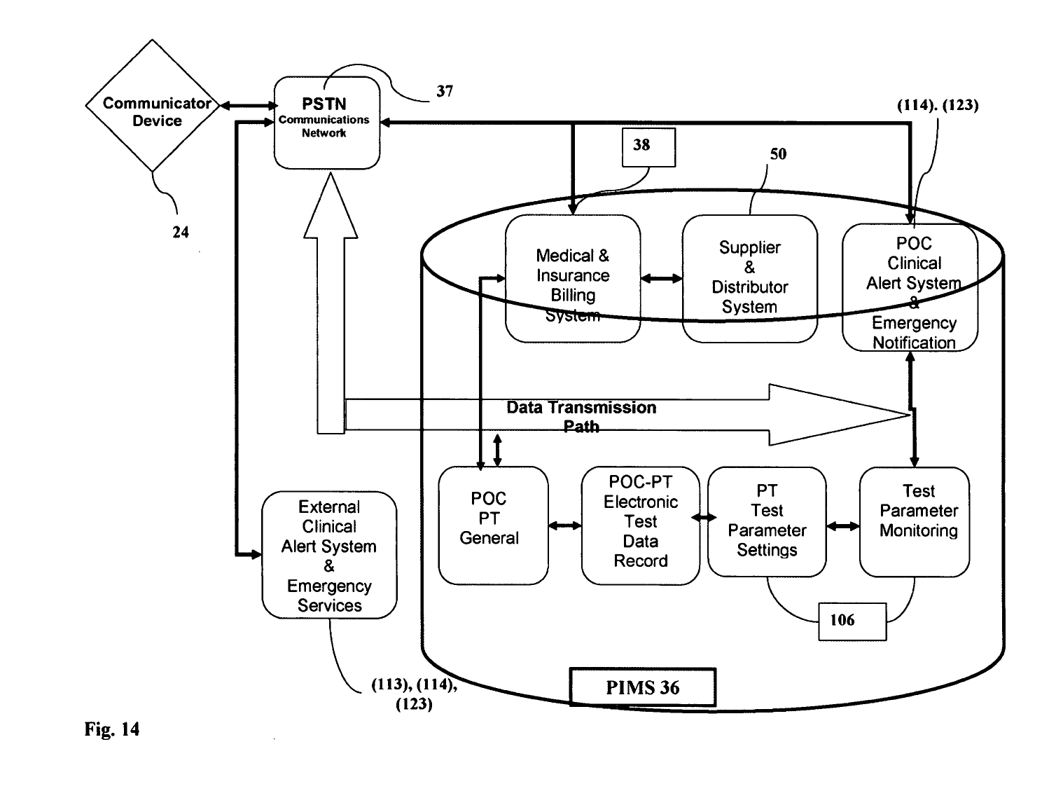

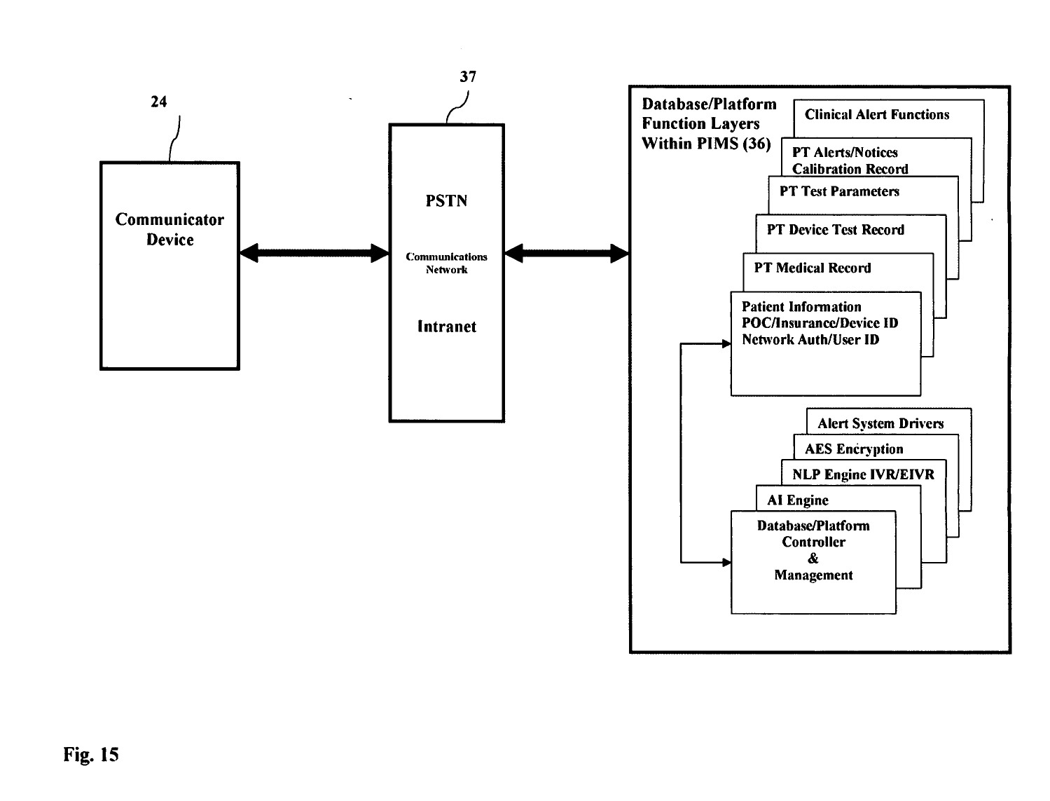

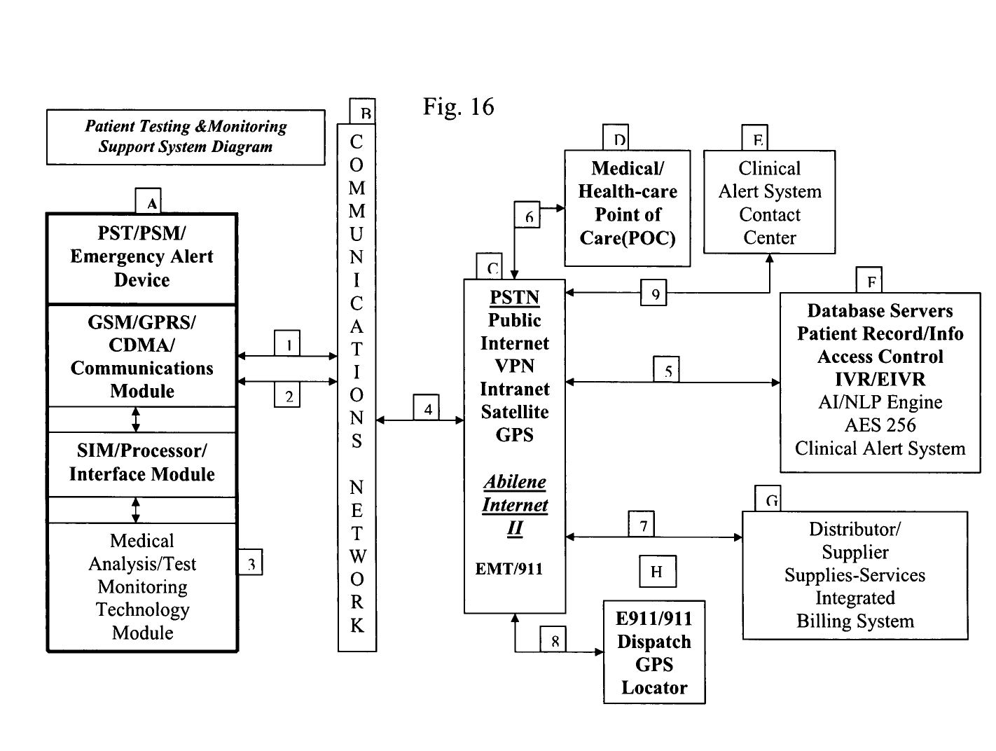

FIG. 13 depicts the overall functional operation of the emergency alert function (111) of the Communicator device. Wherein (111) can be a keypad entry, power button or otherwise dedicated button/function on the device that when pressed in a specific manner or for a specific amount of time (such as “press and hold”), can be utilized by the user to summon emergency aid or services via (110), with user information and location data obtained from (112) through (37) to the system (36) wherein the information is processed by (104) and (113) as determined by parameters, instructions and configurations established by (43) with the resultant action being the transmission of end user information via (37) to (114). Wherein (115) may be utilized by the Communicator user to transmit an alert situation or status directly to (36) via (37), to initialize the same processes as an alert generated by (111). Wherein upon a Communicator user alert condition is determined, in accordance with parameters and instructions set into (36) by (43), the system can transmit Communicator user information to (114) containing or based on information contained in (104). For Example: The system (36) receives an auto-generated alert from the Communicator via (110) and (96) with data from (112). Upon confirmation of the information, (36), based on parameters set by (43), can provide information from (104) via (113) and (37) to be transmitted or passed to responding personnel.

What is claimed is:

1. An information management, analysis and response generation system comprising:
a means for data collection;
a means for transferring data to a central system;
a user information management system:
a means for communication between an automated system and a third party;
a user-accessible data display interface.

2. A system according to claim 1 wherein said means for data collection is selected from the group consisting of a medical testing device, a machine to machine communications device, a third party communications device, a device into which machine to machine communications technology is integrated.

3. A system according to claim 1 wherein the means of transferring data to a central system is selected from the group consisting of a machine to machine communications device, a third party communications device, and a device into which machine to machine communications technology is integrated.

4. A system according to claim 1 wherein the means for transferring data to a central system further includes a means for bi-directional data transmissions.

5. A system according to claim 4 further including a biometric bi-directional user validation system.

6. A system according to claim 1 wherein said user information management system further comprises a record depository and an intelligent data analysis system.

7. A system according to claim 1 wherein the user is capable of appending data transmitted to said system.

8. A system according to claim 6 further comprising parameters for triggering directional communications.

9. A system according to claim 6 further comprising parameters for triggering interactive bi-directional communications.

10. A system according to claim 6 further comprising a means for generating records of direct bi-directional communications.

11. A system according to claim 6 further comprising a means for providing audit capabilities.

12. A system according to claim 6 wherein said intelligent data analysis system further comprises algorithm driven statistical analyses.

13. A system according to claim 6 wherein said intelligent data analysis system further comprises a means for generating reports based on the information collected in said record depository.

14. A system according to claim 6 wherein said intelligent data analysis system further comprises a means for surveillance data analysis.

15. A system according to claim 6 wherein said intelligent data analysis system further comprises an artificial intelligence natural language processor.

16. A system according to claim 1 wherein said information management system supports the integration of multiple data sources that interact with said information management system.

17. A system according to claim 6 wherein said intelligent data analysis system further comprises a means for data pattern recognition and automatic information update capabilities.

18. A system according to claim 6 wherein said information management system further comprises a means for performing comparative analyses.

19. A system according to claim 1 wherein said a communication between an automated system and a third party comprises in-bound and out-bound tier one and two contact center capabilities.

20. A system according to claim 1 wherein said means for communication between an automated system and a third party is facilitated by a clinical alert system.

21. A system according to claim 1 wherein said means for communication between an automated system and a third party are triggered by out of parameter testing results.

22. A system according to claim 1 wherein said user-accessible data display interface includes multiple levels of accessibility to information contained in the system.

23. A system according to claim 1 wherein access to said user-accessible data display interface is secure.

24. A system according to claim 1 wherein said user-accessible data display interface allows users to set testing parameters which trigger said means for communication between an automated system and a third party.

25. A communicator device comprising:
a means for data collection;
a communications module;
a means for communicating with a central system;
a means for connecting to a communications network;
a means for user identification;

26. A communicator device according to claim 23 wherein the technology is imbedded into an existing third party apparatus.

27. A communicator device according to claim 23 wherein said means for user identification is a biometric measurement module.

28. A communicator device according to claim 23 further comprising a means for appending the collected data.

29. A communicator device according to claim 26 wherein said means for appending collected data is an interactive query interface.

30. A communicator device according to claim 26 wherein appended data is sent to a central system.

31. A communicator device according to claim 23 wherein the communication with a central system is a secure connection.

32. A communicator device according to claim 23 wherein the communication with a central system comprises the exchange of encrypted data content.

33. A communicator device according to claim 23 further comprising an emergency alert trigger.

34. A communicator device according to claim 23 wherein said means for data collection is a biophysical testing module.

35. A communicator device according to claim 23 wherein data is transmitted to a central system over a wireless communications connection.

36. A communicator device according to claim 23 wherein data is transmitted to a central system over a physical connection.

37. A communicator device according to claim 23 wherein the device is able to identify users using data stored in the internal memory of said device.

38. Process of transmitting data between a user and a designated third party comprising:
a collection of data using a data collection device;
a communication of the collected data using a communicator device;
transmitting that data over a communications network;
the receipt and analysis of that data using a central system;
transmitting the data to and from a third party access module.

39. A process according to claim 36 of communicating information between a user and a designated third party wherein the communications are bi-directional.

40. A process according to claim 36 of analyzing data collected from a remote device and using analyzed data to trigger system responses.

41. A process of triggering clinical alerts/responses based on analysis of data collected from the user.

42. A process according to claim 39 wherein said responses are triggered by parameters entered into the central system by a third party.

43. A process according to claim 36 wherein the data collected from the user is an oral communication.

44. A process according to claim 41 wherein said oral communications are analyzed and recorded by a central system.

45. A process according to claim 36 wherein the data collected from the user is a biometric reading.

46. A process according to claim 36 wherein the central system converts outbound data transmissions it into oral responses.

47. A process according to claim 36 wherein the third party access module is an administrative access terminal.

48. A process for analyzing data comprising the steps of:
collecting data;
classifying of the collected data;
storing the data in a data repository;
analyzing the collected data using an artificial intelligence data analysis system;
communicating information to third parties through a notification interface.

49. A process for system user authentication comprising the steps of:
collecting a biometric identification reading;
using the biometric identification reading to identify existing user profiles;
communicating the data collected to a support system.
